(19) United States
(12) Patent Application Publication
(10) Pub. No.: US 2003/0168292 A1
(43) Pub. Date: Sep. 11, 2003

(54) Bicycle brake pad assembly

(76) Inventor: Yung-Pin Kuo, Chang Hwa City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/277,954

(22) Filed: Oct. 23, 2002

(30) Foreign Application Priority Data
Mar. 5, 2002 (TW) 091202670

(51) Int. Cl. B62L 1/00; F16D 65/00

(52) U.S. Cl. 188/24.11; 188/24.12; 188/73.1

(57) ABSTRACT

A bicycle brake assembly includes a support member having a support base and a rod extending from a first side of the support base so as to be connected to the brake arms of the brake mechanism. A first brake pad and a second brake pad are respectively connected on a second side of the support base. The first brake pad has a wedge-shaped end defined at a leading end thereof so as to avoid mud from being attached on the first brake pad, and a groove which is defined in the first brake pad in a radial direction of the rotation of a wheel. A plurality of recesses are defined in the second brake pad so as to absorb the noise when braking.

### FIELD OF THE INVENTION

The present invention relates to a bicycle brake pad assembly includes two brake pads connected on a support member and one of the two brake pads has a wedge end for preventing mud from being attached on the brake pad and the other pad has recesses for reducing noise.

### BACKGROUND OF THE INVENTION

A conventional bicycle brake pad 60 is shown in FIG. 5 and generally includes a longitudinal body with transverse grooves 61 defined in a surface thereof and operation surfaces 62 are separated by the grooves 61. However, the direction of rotation of the wheel shown by the arrow is perpendicular to the direction of the grooves 61 so that water cannot be drained off from the contact surface between the operation surfaces 62 and the wheel rim (not shown). The water reduces the friction between the wheel rim and the brake pad 60 and causes less brake force on the wheel. FIG. 6 shows another embodiment of the conventional bicycle pad 70 wherein the grooves 71 is arranged at a direction that is the same as the direction of rotation of the wheel so that water is guided from the grooves 71. Nevertheless, mud could be stuffed in the grooves 71 and affects the function of the grooves 71.

The present invention intends to provide a brake pad assembly wherein mud and water can be guided away from the pad so that the brake pad functions as desired.

### SUMMARY OF THE INVENTION

In accordance with one aspect of the present invention, there is provided a brake assembly which comprises a support member with a support base and a rod which is connected to the brake mechanism. A first brake pad and a second brake pad are respectively connected on the support base. A wedge-shaped end is defined at a leading end of the first brake pad and a groove is defined in the first brake pad and extends in a radial direction of the rotation of a wheel. A plurality of recesses are defined in the second brake pad.

The primary object of the present invention is to provide a brake pad that effectively prevents mud and water from being trapped between the brake pad and the wheel rim.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the brake pad assembly of the present invention;

FIG. 2 is an exploded view to show the brake pad assembly of the present invention;

FIG. 3 shows the brake pad of the present invention has a wedge-shaped end which faces the direction of rotation of the wheel;

FIG. 4 shows the brake pad assemblies are connected to brake arms on a bicycle frame, and

FIGS. 5 and 6 show two conventional brake pads.

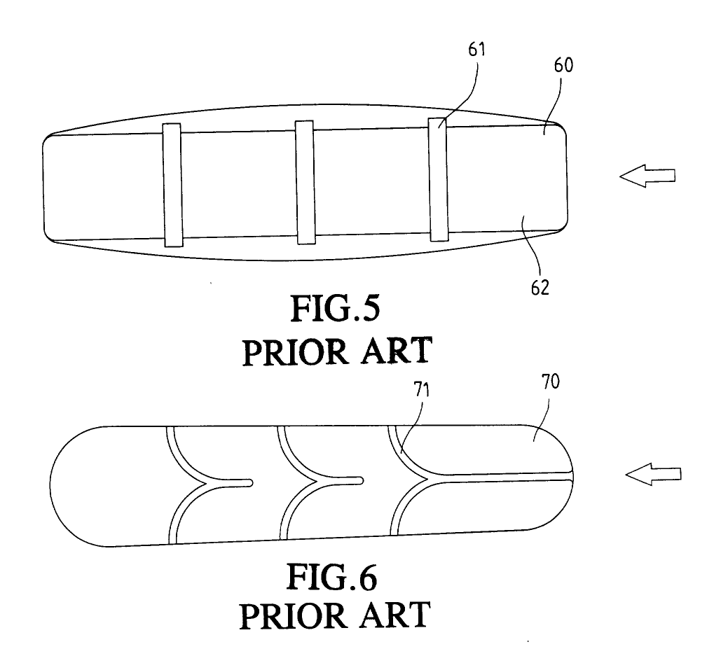

### DETAILED DESCRIPTION OF THE PREFERRED EMBODIMENT

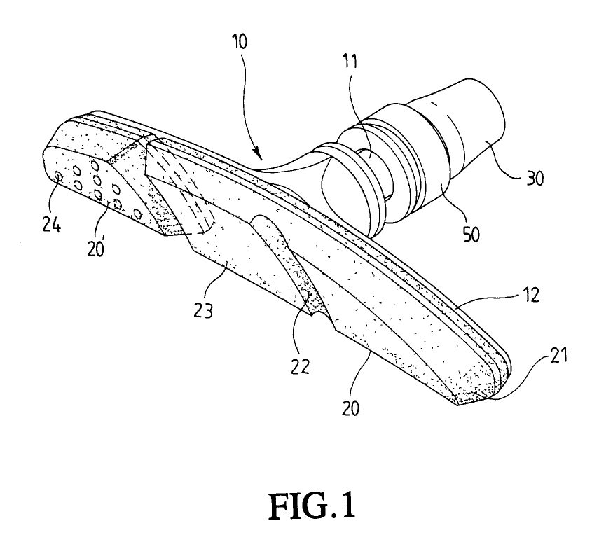

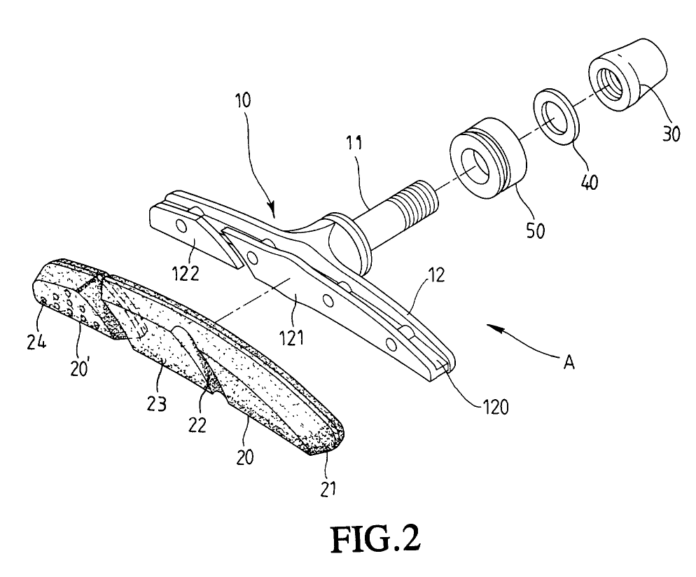

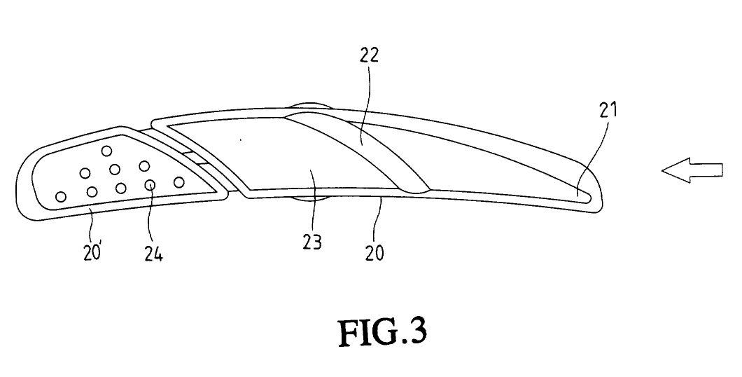

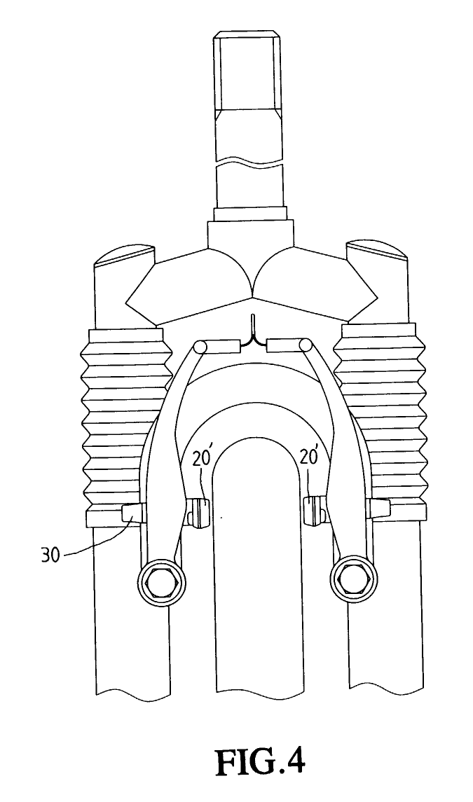

Referring to FIGS. 1 to 3, the brake pad assembly of the present invention comprises a support member 10 which has a support base 12 and a rod 11 extends from a first side of the support base 12 such that the brake pad assembly can be connected to a brake arm of a brake mechanism as shown in FIG. 4 by an urging collar 50, a washer 40 and a locking nut 30.

A first support frame 121 and a second support frame 122 are connected on the second side of the support base 12 by two respective connection plates 120. A first brake pad 20 and a second brake pad 20′ are respectively mounted on the first support frame 121 and the second support frame 122. The first support frame 121 and the second support frame 122 can be made by metal or stiff material.

A wedge-shaped end 21 is defined at a leading end of the first brake pad 20 and a groove 22 defined in the first brake pad 20. The wedge-shaped end 21 faces the direction of rotation (shown by the arrow) of the wheel which the brake pad assembly is connected and the groove 22 is defined in a radial direction of the rotation of the wheel. A brake end 23 is located at the opposite end to the wedge-shaped end 21 of the first brake pad 20. The brake end 23 is larger than the wedge-shaped end 21 and provides sufficient brake area. By the arrangement, the wedge-shaped end 21 effectively splits mud or water that comes toward the first brake pad 20. The groove 22 is just suitable to guide water to leave from the first brake pad 20 by eccentric force. A plurality of recesses 24 are defined in the second brake pad 20′ and noise-absorbing material is stuffed in the recesses 24 in the second brake pad 20′ so that when the second brake pad 20′ contacts the wheel rim, noise will not be heard. The shapes of the recesses 24 can be varied according to needs. A gap is defined between the first brake pad 20 and the second brake pad 20′ so that when braking, the first brake pad 20 can be deformed without interference to the second brake pad 20′.

While we have shown and described the embodiment in accordance with the present invention, it should be clear to those skilled in the art that further embodiments may be made without departing from the scope of the present invention.

What is claimed is:

1. A brake assembly comprising:
a support member having a support base and a rod extending from a first side of the support base, a first brake pad and a second brake pad respectively connected on a second side of the support base, a wedge-shaped end defined at a leading end of the first brake pad and a groove defined in the first brake pad, the groove adapted to be defined in a radial direction of the rotation of a wheel, a plurality of recesses defined in the second brake pad.

2. The brake assembly as claimed in claim 1, wherein support member includes a first support frame and a second support frame, the first brake pad mounted on the first support frame and the second brake pad mounted on the second support frame.

3. The brake assembly as claimed in claim 1 further comprising noise-absorbing material stuffed in the recesses in the second brake pad.

4. The brake assembly as claimed in claim 2 wherein each of the first support frame and the second support frame is connected to the support base by a connection plate.
